(19) United States
(12) Patent Application Publication
(10) Pub. No.: US 2017/0036315 A1
(43) Pub. Date: Feb. 9, 2017

(54) Method for Operating a Hand-Held Power Tool, Hand-Held Power Tool

(71) Applicant: Robert Bosch GmbH, Stuttgart (DE)

(72) Inventors: Bernd Wimitzer, Friolzheim (DE); Christoph Steurer, Urbach (DE)

(21) Appl. No.: 15/304,224

(22) PCT Filed: Apr. 9, 2015
(86) PCT No.: PCT/EP2015/057711

§ 371 Date: Oct. 14, 2016

(30) Foreign Application Priority Data
Apr. 17, 2014 (DE) 10 2014 207 434.7

(51) Int. Cl. B23Q 17/12; B25F 5/00

(52) U.S. Cl. CPC B23Q 17/12; B25F 5/00

(57) ABSTRACT

The disclosure relates to a method for operating a hand-held power tool comprising at least one acceleration sensor, said hand-held power tool being monitored for any faults and the operating behavior thereof being influenced when a fault is sensed. The disclosed method involves the following steps: having the acceleration sensor sense vibrations of the hand-held power tool, comparing the sensed vibrations with previously stored reference vibrations, identifying a fault of the hand-held power tool when the sensed vibrations differ from the reference vibrations by a predefined measure.

The invention relates to a method for operating a hand-held power tool, and to a corresponding hand-held power tool.

### PRIOR ART

Usually, hand-held power tools are operated in that the user specifies a desired output, for example by actuating a switching means, which is implemented by a drive means and used to drive a tool. The user can thereby determine, for example, the rate of rotation, or the rotational speed, of a drill or screwdriver, or also the working speed of a saw blade or the like. Frequently in this case, a control means is provided, which monitors, in particular, the drive means in respect of its functional capability, in order to adjust the operation of the hand-held power tool if necessary or, for example, to indicate a fault message to the user by means of an acoustic signal. Frequently, however, the monitoring necessitates elaborate electronics, which monitor and evaluate, for example, the operating currents of an electric drive means.

### DISCLOSURE OF THE INVENTION

The method according to the invention for operating a hand-held power tool has the advantage that it is possible to dispense with elaborate electronics, and that a defect or malfunction of the hand-held power tool can be deduced with simple means. For this purpose, it is provided that an acceleration sensor monitors the hand-held power tool for vibrations. If vibrations are sensed, they are compared with previously stored reference vibrations, and a defect of the hand-held power tool is identified if the sensed vibrations deviate beyond a predefinable extent from the reference vibrations. If a malfunction occurs in the hand-held power tool, this will normally also be transferred to the vibration behavior of the hand-held power tool during operation, or during working of a workpiece. For example, if an electric control of the drive means is not working correctly, this may result in vibrations on the hand-held power tool. Owing to the provision of the acceleration sensor, these vibrations are then sensed and used to identify a defect of the hand-held power tool. It is not in this case initially of importance that the precise defect of the hand-held power tool can be determined. Initially, it suffices to assess whether or not a defect is present. For this purpose, the sensed vibrations are compared with the reference vibrations. If the sensed vibrations deviate excessively from the reference vibrations, a defect is identified, and the operation of the hand-held power tool is influenced, as described previously. It is thereby possible to dispense with an elaborate means of monitoring the hand-held power tool. The reference vibrations are determined, for example, by prior experiments.

According to a preferred development of the invention, it is provided that, if a defect is sensed, an output, in particular the maximum output of the hand-held power tool, or at least a parameter that influences the output, is reduced. In this case, a parameter that influences the output is understood to mean, in particular, a supply voltage or a supply current. It is thus provided in this case that the operation of the hand-held power tool is influenced in such a manner that the output of the hand-held power tool is reduced, such that the theoretically available output is no longer made available to the user. In particular, the maximum output of the hand-held power tool is reduced, such that the user can use the hand-held power tool, but cannot exploit its full output. This has the effect, for example, that overloading of the hand-held power tool, which could result in further damage because of the defect, is avoided. For the user, safety in use of the tool is also increased as a result.

According to an advantageous development of the invention, it is provided that the reduction of the output or of the parameter is effected in dependence on a current operating state of the hand-held power tool. It is thus provided, in particular, that the output or the parameter is reduced or influenced only when the rotational speed of the tool or of the drive means decreases, for example because the user requests a correspondingly lower output. Alternatively or additionally, it is provided that the output is reduced in dependence on a selected gear speed, in the case of a hand-held power tool that, correspondingly, has a multispeed transmission. If, however, without a change, the user requests a (high) rotational speed when the defect occurs, the output of the hand-held power tool is not influenced, in order that the commenced work operation can be brought safely to an end, without the user being irritated by a sudden loss of output.

It is additionally preferably provided that, if a defect is sensed, a coasting down tool of the hand-held power tool is braked. This is preferably also provided when the defect has been detected in a conventional manner. For example, in the case of many hand-held power tools, if the user ends the actuation of the switching means for specification of a desired output of the hand-held power tool, it is provided that the tool driven by the drive means coasts down until it comes to a standstill by itself, as a result of friction. In the present case, however, it is preferably provided that, if a defect has been sensed, the coasting down tool is actively braked, in order to bring the hand-held power tool into a safe state as rapidly as possible. For this purpose, the tool and/or the drive means expediently have/has a corresponding braking means that, if a defect is detected, can be controlled by the control means to brake the tool.

It is furthermore preferably provided, according to a development or an alternative embodiment, that the operation of the hand-held power tool is allowed only when no accelerations, or substantially no accelerations, are sensed by the acceleration sensor. This achieves the effect that, before a work operation is performed, it is checked whether the hand-held power tool is kept running smoothly by the user. Only when it is established that no accelerations, or only slight accelerations, is or are occurring, is it assumed that the user is keeping the hand-held power tool running sufficiently smoothly to enable a work operation to be performed safely.

According to a particularly preferred development of the invention, it is furthermore provided that, in the case of a defect having been identified, the sensed vibrations are stored in memory and, upon the hand-held power tool being put back into operation, are compared with currently sensed vibrations, wherein the operation of the hand-held power tool is influenced in dependence on the comparison. Advantageously, upon the hand-held power tool being put back into operation, the hand-held power tool is always checked anew, in the manner described above, for the presence of a defect. If defect has been identified, and the operating behavior of the hand-held power tool has been influenced accordingly, then, upon the hand-held power tool being again put back into operation, the operating behavior thereof is influenced anew. According to an alternative method, the defect is stored in memory, irrespective of how it was sensed, and is taken into account as described above upon the hand-held power tool being put back into operation.

The comparison of the stored vibrations with the currently sensed vibrations makes it possible to identify rapidly whether the previously identified defect of the hand-held power tool is still present. Accordingly, the operating behavior of the hand-held power tool can rapidly be influenced anew.

Preferably, in the case of the hand-held power tool being put back into operation and there being already stored vibrations or a stored defect, the output of the hand-held power tool is reduced, such that the hand-held power tool operates with a reduced output from the outset, if a defect was identified in the last work operation to be performed. The operational safety is thereby increased.

Preferably, if, upon the hand-held power tool being put back into operation, the defect is not detected anew, the reduction of the output is cancelled and, in particular, the previously stored vibrations, or data, are erased.

According to an advantageous development or alternative embodiment of the invention, it is additionally provided that a rotational speed sensor of the hand-held power tool is monitored in respect of its functional capability, and that, if a malfunction of the rotational speed sensor is detected, a changeover is effected from closed-loop drive control to open-loop drive control. To some extent, electric drive means of hand-held power tools are realized with closed-loop rotational speed control. If it is detected that a rotational speed sensor is no longer functioning properly, then the closed-loop rotational speed control is also no longer being performed properly. Accordingly, if a defect of the rotational speed sensor is detected, a changeover is effected from the closed-loop control to an open-loop drive control, to enable continued, if also limited, operation of the hand-held power tool.

The hand-held power tool according to the invention, having the features of claim 10, is distinguished by a specially made control means for executing the method according to the invention. The advantages already mentioned ensue in this case.

The invention is to be explained in greater detail in the following on the basis of the drawing. For this purpose:

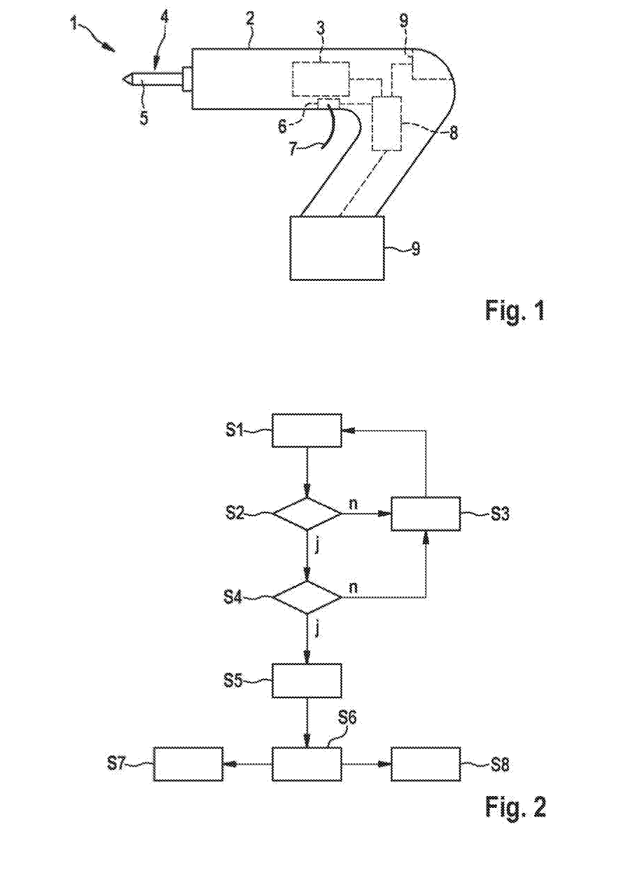

FIG. 1 shows a hand-held power tool, in a simplified representation, and

FIG. 2 shows an exemplary embodiment of an advantageous method for operating the hand-held power tool.

Shown in a simplified representation in FIG. 1 is a hand-held power tool 1, which in the present case is realized as a power drill. For this purpose, the hand-held power tool 1 has a pistol-shaped housing 2, disposed in which there is a drive means 3. The drive means 3 is realized as an electric motor, which is operatively connected to a tool 4, in this case realized as a drilling bit 5, to drive the latter. The hand-held power tool 1 additionally has a switch means 6, which has a displaceable, in particular slidable or swivelable, switching lever 7. The switch means 6 senses the position of the switching lever 7 and transmits this to a control means 8. The control means 8 is connected to the switch means 6, to an, in particular exchangeable, energy storage means 9, and to the drive means 3, in order to control the drive means 3 in dependence on the position of the switching lever 7. By actuating the switching lever 7, a user can thus specify a desired output, in particular a desired rotational speed and/or desired torque, to be delivered by the drive means 3. The desired output in this case may be specified, for example, as a torque and/or a rotational speed.

The control means 8 is additionally connected to an acceleration sensor 9, which is likewise disposed in the housing 2 of the hand-held power tool 1. The acceleration sensor 9 senses the continuous acceleration of the hand-held power tool 1, and sends the sensed measured values to the control unit 8, which evaluates them.

The control unit 8 in this case operates as described in the following with reference to FIG. 2.

In a first step S1, the control unit 8 senses that the switch lever 7 is being actuated. As a result, the control unit 8 controls the drive means 3 to deliver the output desired by the user. In a step S2, the control unit 8 evaluates the measured values supplied by the acceleration sensor 9, in order to check whether there are accelerations acting on the hand-held power tool 1. If there are no, or no critical, accelerations acting on the hand-held power tool 1, then, in a following step S3, the hand-held power tool 1 is operated as desired by the user. If appropriate, it may be provided that the operation of the hand-held power tool 1 has already been enabled if it is sensed, in the step S2, that there are no, or no critical, accelerations acting (n) on the hand-held power tool 1, such that it may be assumed that the user is keeping the hand-held power tool 1 running sufficiently smoothly to enable a work operation to be performed in a safe and precise manner.

However, if it is sensed in the step S2 that there are accelerations acting (j) on the hand-held power tool 1, then, in a subsequent step S4, a comparison is performed, in which the vibrations sensed by the acceleration sensor 9 are compared with reference vibrations stored previously in a non-volatile memory. The reference vibrations in this case are specified, in particular, in dependence on the position of the switching lever 7, or in dependence on the desired output of the hand-held power tool 1 and/or on a rotational speed and/or the type of a workpiece on which work is to be performed, such that a reference vibration characteristic curve or a reference vibration characteristic map is available for comparison with the currently sensed vibrations. The reference vibrations were determined beforehand in experiments and stored in memory, averaged if necessary. If it is ascertained in the comparison in step S4 that the sensed vibrations correspond, at least substantially, to the reference vibrations, it is thereupon identified that the hand-held power tool 1 is behaving as expected and therefore normally (n), such that the method proceeds with step S3. However, if it is ascertained (j) that the vibrations deviate beyond a predefinable extent from the reference vibrations, then in step S5, it is identified that there must be a defect of the hand-held power tool 1. The defect in this case may be caused both by a broken tool 4 or by a drive means 3 not working properly, or the like. The precise cause of the defect is not initially of importance in this case. If a defect has been identified, then, in a subsequent step S6, the operating behavior of the hand-held power tool 1 is influenced. For this, there are various available possibilities that, for example, also ensue in dependence on the current operating state of the hand-held power tool 1.

As one possibility, it is provided that, in a step S7, the output of the hand-held power tool 1 is reduced. It is provided in this case, in particular, that the maximally attainable output of the hand-held power tool 1 is reduced, such that the full output of the electric hand-held power tool is no longer available to a user actuating the switch means 6. In particular, the maximum rotational speed and/or the maximum torque of the drive means 3 are/is reduced. This increases the safety in the use of the hand-held power tool 1 if there is a defect present. The reduction of the output in this case is preferably effected in dependence on certain operating states of the hand-held power tool 1. It is thus provided, in particular, that the output of the hand-held power tool 1 is reduced only when the rotational speed of the tool 4 decreases, i.e. if the user themselves specifies a reduction of the output of the hand-held power tool 1. This avoids the situation in which the output required by the user is suddenly absent during operation, catching the user unawares. It is also conceivable to reduce the output in dependence on a selected gear speed of a multispeed transmission that may be assigned to the electric drive means 3, such that, for example in the case of differing gear ratios of the multispeed transmission, differing output reductions are provided. In extreme cases, for example if the sensed vibrations exceed the reference vibrations by a predefinable limit value, the hand-held power tool 1 is shut down, the output is thus reduced to 0, and preferably further operation of the hand-held power tool 1 is prevented, or not allowed.

If it is detected as an operating state of the hand-held power tool 1 that the user, by releasing the switching lever 7, is letting the tool 4 coast down, then the tool 4 is preferably actively braked if a defect has been detected in the manner described above or, additionally or alternatively, in another manner. As a result, coasting-down of the tool 4 is prevented and a rapid braking of the tool 4 is achieved, such that, in the case of occurrence of a defect, the safety of the hand-held power tool 1 is further increased. Alternatively or additionally, in this case the defect may be acoustically or visually indicated to the user.

Alternatively or additionally, in a step S8, the detected or identified defect is stored in memory. For this purpose, the previously generated fault message is stored in a volatile or non-volatile memory. In particular, the previously sensed vibrations that deviate beyond a predefinable extent from the reference vibrations are stored in the memory, such that, upon the hand-held power tool 1 being put back into operation, i.e. upon a subsequent re-start, the fault is already known. If the hand-held power tool 1 is then started anew, the vibrations sensed by the acceleration sensor 9 are compared with the stored vibrations and, if the same defect occurs anew, the precautions described in step S7 are effected. A comparison of the currently sensed vibrations with the stored vibrations makes it possible to rapidly deduce whether it is the same defect.

If, however, upon the hand-held power tool being put back into operation, it is ascertained that the currently sensed vibrations differ from the stored or vibrations, then the previous error message is erased again, or the stored vibrations are erased again, from the memory. Only if the currently sensed vibrations again exceed the reference vibrations beyond the predefinable extent is a fault identified and stored in the memory.

Alternatively, it is provided that the output of the hand-held power tool 1 is already limited when the hand-held power tool is put back into operation. Only if it is ascertained that the currently sensed vibrations correspond, at least substantially, to the reference vibrations is the limitation, or the reduction of the output, cancelled again, since it is then assumed that the defect is no longer present.

If it is provided, according to a further exemplary embodiment, not represented here, that the drive means 3 has a rotational speed sensor, the latter is checked by the control unit 8, preferably likewise continuously, in respect of functionality. If it is ascertained in this case that the rotational speed sensor is defective, the closed-loop rotational speed control of the drive means 3 is converted into an open-loop rotational speed control, to enable continued operation of the hand-held power tool 1, at least in an emergency operating mode.

If the hand-held power tool 1 is realized as a hammer drill, the acceleration sensor 9 may also be used to determine the rotational speed of the hammer drill on the basis of the impacts sensed by the acceleration sensor. To that extent, the acceleration sensor 9 could be used for indirect sensing of rotational speed. In the case of a defect of the acceleration sensor 9, the procedure then ensues accordingly, as previously described, and the closed-loop rotational speed control is changed to an open-loop rotational speed control. In particular, the defect is additionally indicated visually or acoustically to the user.

If the hand-held power tool 1 is realized as a riveting machine, the acceleration sensor senses, in particular, whether there are no movements, or only slight movements, effected within a predefinable time window, as already described in connection with step S2. Only if it is confirmed that the hand-held power tool 1 is being kept running smoothly is a riveting or nailing operation allowed. The working safety is thereby increased. In particular, the enabling of operation is effected by action in combination with a contact-pressure sensor, which senses the placing of the hand-held power tool 1, in particular the riveting/nailing machine, onto a workpiece, such that a work operation is allowed only if the hand-held power tool 1 has been placed onto the workpiece and accelerations are sufficiently slight.

1. A method for monitoring a hand-held power tool having at least one acceleration sensor, the method comprising:
sensing vibrations of the hand-held power tool using the at least one acceleration sensor;
comparing the sensed vibrations with previously stored reference vibrations;
detecting a defect of the hand-held power tool in response to the sensed vibrations deviating beyond a predetermined threshold from the reference vibrations; and
influencing an operating behavior of the hand-held power tool in response to detecting the defect.

2. The method as claimed in claim 1, the influencing of the operating behavior further comprising:
reducing at least one of (i) a maximum output of the hand-held power tool, and (ii) a parameter that influences the maximum output in response to detecting the defect.

3. The method as claimed in claim 2, the reducing further comprising:
reducing the at least one of (i) the maximum output and (ii) the parameter in dependence on a current operating state of the hand-held power tool.

4. The method as claimed in claim 1, the influencing of the operating behavior further comprising:
braking a coasting down tool of the hand-held power tool in response to detecting the defect.

5. The method as claimed in claim 1, further comprising:
operating the hand-held power tool only when accelerations sensed by the acceleration sensor are less than a predetermined threshold.

6. The method as claimed in claim 1, the influencing of the operating behavior further comprising:
storing the sensed vibrations are stored in a memory in response to detecting the defect; and
upon the hand-held power tool being put back into operation, comparing the sensed vibrations that were stored in the memory with currently sensed vibrations,
wherein the operating behavior of the hand-held power tool is changed in dependence on the comparison of the sensed vibrations that were stored in memory with the currently sensed vibrations.

7. The method as claimed in claim 1, the influencing of the operating behavior further comprising:
storing the defect in a memory in response to detecting the defect; and
upon the hand-held power tool being put back into operation, reducing at least one of (i) a maximum output of the hand-held power tool and (ii) a parameter that influences the maximum output.

8. The method as claimed in claim 2, further comprising:
upon the hand-held power tool being put back into operation, cancelling the reduction of the at least one of (i) the output and (ii) the parameter and erasing the previously stored reference vibrations in response to the defect no longer being detected.

9. The method as claimed in claim 1, further comprising:
monitoring a rotational speed sensor of the hand-held power tool to detect a malfunction of the rotational speed sensor; and
changing over from closed-loop drive control to open-loop drive control in response to detecting the malfunction of the rotational speed sensor.

10. A hand-held power tool comprising:
an electric drive;
a tool configured to be driven by the electric drive;
at least one acceleration sensor configured to sense vibrations of the hand-held power tool; and
a controller configured to:
sense vibrations of the hand-held power tool using the at least one acceleration sensor;
compare the sensed vibrations with previously stored reference vibrations;
detect a defect of the hand-held power tool in response to the sensed vibrations deviating beyond a predetermined threshold from the reference vibrations; and
influence an operating behavior of the hand-held power tool in response to detecting the defect.
